(19) United States
(12) Patent Application Publication
(10) Pub. No.: US 2025/0021969 A1
(43) Pub. Date: Jan. 16, 2025

(54) COMPUTERIZED METHOD AND SYSTEM FOR DIGITAL PAYMENTS

(71) Applicant: CRUNCHFISH DIGITAL CASH AB, Malmo (SE)

(72) Inventors: Joachim Samuelsson, Helsingborg (SE); Paul Cronholm, Malmo (SE); Magnus Lageson, Alta (SE)

(21) Appl. No.: 18/710,488

(22) PCT Filed: Nov. 15, 2022
(86) PCT No.: PCT/SE2022/051068

§ 371 Date: May 15, 2024

(30) Foreign Application Priority Data
Nov. 17, 2021 (SE) 2151401-3
Dec. 10, 2021 (SE) 2151517-6

(51) Int. Cl. G06Q 20/38; G06Q 20/36

(52) U.S. Cl. CPC G06Q 20/3829; G06Q 20/3674

(57) ABSTRACT

A computerized method (100) in a digital payment system (1) involves registering (110) of transaction data (TBS) for a digital payment. The transaction data comprises an alias of the payer, an alias of the payee, and a representation of a payment amount which is covered by a reservation of funds in an account managed by the payment service provider. The method involves signing (120) of the transaction data, followed by communicating (130) the signed transaction data (P, TBS) to enable verification (140) at the payment service provider or payment server function. The payee communication device (PD2) receives (132) the signed transaction data (P, TBS) which includes a specification of a verification resource and uses (912) the specification of the verification resource to make a verification request (134; 914) at the payment service provider or payment server function. Subject to successful verification, the method concludes to enable settlement (150) of the digital payment.

### TECHNICAL FIELD

The present invention generally relates to the field of digital payments. More particularly, the present invention relates to technical improvements to achieve a versatile ecosystem for digital payments. Even more particularly, the present invention relates to a computerized method of performing a digital payment by a payer to a payee in a digital payment system, and to the digital payment system as such. Moreover, the invention relates to associated communication devices, cloud-based computing resources, computer program products and computer readable media.

### BACKGROUND

As everybody knows, there has been an overwhelming market penetration for communication devices such as smart phones, tablets and personal computers. Typically, such communication devices are enabled for wide-area network, WAN, communication (broadband RF-based or wired communication) with remote entities, for instance via cellular radio systems like 5G, UMTS or GSM, or via wireless local area network, WLAN, access to route IP traffic to and from such remote entities. In addition, communication devices are often enabled for short-range wireless data communication, such as Bluetooth, with other devices nearby. Such a nearby device may for instance be an accessory or peripheral device, like a wireless headset or wireless speakers.

Thanks to this ability, users of communication devices may enjoy a plethora of digital services that involve communication with cloud-based resources. A very popular type of such digital services is digital payments. Throughout this document, the term “digital payment” is to be construed broadly to embrace any kind of transfer of economic value in digital form on behalf of or between people of any types, roles etc.

The present inventors have identified some shortcomings of existing digital payment systems. For instance, interoperability between payment services may be hard to achieve. In order to receive a digital payment from a payer, the payee will typically have to perform onboarding activities. This may, for instance, involve installation of proprietary software and data on the payee's communication device. Furthermore, some existing solution are based on a security regime that requires a certain sophisticated hardware or software platform, such as a secure element or trusted execution environment. Also, it is typically required that the payee has an existing service subscription or payment account at the payment service provider used by the payer, and/or that the identity of the payee and/or payer must be positively known by the payment system.

A frequent situation is that a digital payment is part of an exchange of goods or services subject to a payment. The payer makes a digital payment to the payee, in exchange of which the payee is to hand over or delivery certain goods or perform certain services. From the payee's perspective, it is important to be able to rely on the solvency of the digital payment, i.e. that the payee can rely on the digital payment and trust the payer to the extent that the payee will be able to retrieve an actual monetary value from the received digital payment.

From the perspectives of both the payer and the payee, and considering the truly mobile nature of contemporary communication devices, it would be beneficial if the digital payments could be performed in various different situations of communication ability.

### SUMMARY

In line with the observations above, the present inventors have made valuable technical insights. These insights will be presented as inventive aspects below as well as in the attached independent claims. The list of inventive aspects is not to be seen as exhaustive but rather a summary of particularly beneficial inventive aspects. The inventive aspects will be exemplified by reference to disclosed embodiments which are shown in the enclosed drawings. The inventive aspects are not as such limited to the disclosed embodiments, as the skilled reader will understand.

A first inventive aspect is a computerized method of performing a digital payment by a payer to a payee in a digital payment system which comprises at least the following entities: a computerized payment service provider, a payer communication device for use by the payer, a payee communication device for use by the payee, and a computerized payment server function. The computerized method involves the payer communication device or the payment service provider registering transaction data for the digital payment. The transaction data comprises an alias of the payer, an alias of the payee, and a representation of a payment amount which is covered by a reservation of funds in an account managed by the payment service provider.

The computerized method further involves the payer communication device or the payment service provider signing the transaction data by means of a private cryptographic key kept secure by the payment service provider or payer communication device, and communicating the signed transaction data to enable verification at the payment service provider or payment server function by means of a certified public cryptographic key corresponding to the private cryptographic key.

The computerized method further involves the payee communication device receiving the signed transaction data, wherein the signed transaction data includes a specification of a verification resource, and using the specification of the verification resource to make a verification request at the payment service provider or payment server function. Subject to successful verification, the computerized method moreover involves enabling settlement of the digital payment by releasing the payment amount from the reservation of funds, deducting funds from a balance of said account and adding funds to an account associated with the payee, wherein the deduction and addition correspond to the payment amount.

This computerized method and the digital payment system in which it is executed will allow payees to receive and accept digital payments in a convenient and trustworthy manner without requiring them to have any particular knowledge of the payers or the payment service provider used by the payers and without needing to perform any preparatory onboarding steps in order to enjoy the payment service. The computerized method enables interoperability since the digital payments can be performed between respective payers and payees being clients at different payment service providers. In other words, a digital payment can be made by a certain payer, being a client at a certain payment service provider, to a payee which is not an existing client at that payment service provider. Moreover, the computerized method and the digital payment system will enable privacy of payers and payees.

A second inventive aspect is a digital payment system of performing a digital payment of a payment amount between a payer and a payee according to the attached independent system claim. The digital payment system may further be configured for performed any or all of the functionality of the computerized method according to the first inventive aspect, including any or all of its embodiments and preferred or optional features, as disclosed in this documents together with the appended drawings.

A third inventive aspect is a cloud-based computing resource configured to perform the functionality of the computerized payment server function in the computerized method according to the first inventive aspect, including any or all of its embodiments and preferred or optional features.

A fourth inventive aspect is a cloud-based computing resource configured to perform the functionality of the computerized payment service provider in the computerized method according to the first inventive aspect, including any or all of its embodiments and preferred or optional features.

A fifth inventive aspect is a communication device configured to perform the functionality of the payer communication device in the computerized method according to the first inventive aspect, including any or all of its embodiments and preferred or optional features. The communication device may, for instance, be a mobile communication device, a mobile phone, a smart phone, a tablet computer, a personal digital assistant, a portable computer, smart glasses, a smart wearable, a smart watch, a smart bracelet, a smart card or a smart chip.

A sixth inventive aspect is a communication device configured to perform the functionality of the payee communication device in the computerized method according to the first inventive aspect, including any or all of its embodiments and preferred or optional features. The communication device may, for instance, be a mobile communication device, a mobile phone, a smart phone, a tablet computer, a personal digital assistant, a portable computer, smart glasses, a smart watch, a smart card, a smart bracelet, a smart wearable, a payment terminal, a service terminal, a point-of-sales terminal, a checkout counter, a delivery pickup point, a vending machine, a ticket machine, a dispensing machine, or an access control system.

A seventh inventive aspect is a computer program product comprising computer code for performing the functionality of the computerized payment server function in the computerized method according to the first inventive aspect, including any or all of its embodiments and preferred or optional features, when the computer program code is executed by a processing device.

An eighth inventive aspect is a computer program product comprising computer code for performing the functionality of the computerized payment service provider in the computerized method according to the first inventive aspect, including any or all of its embodiments and preferred or optional features, when the computer program code is executed by a processing device.

A ninth eleventh inventive aspect is a computer program product comprising computer code for performing the functionality of the payer communication device in the computerized method according to the first inventive aspect, including any or all of its embodiments and preferred or optional features, when the computer program code is executed by a processing device.

A tenth inventive aspect is a computer program product comprising computer code for performing the functionality of the payee communication device in the computerized method according to the first inventive aspect, including any or all of its embodiments and preferred or optional features, when the computer program code is executed by a processing device.

An eleventh inventive aspect is a computer readable medium having stored thereon a computer program comprising computer program code for performing the functionality of the computerized payment server function in the computerized method according to the first inventive aspect, including any or all of its embodiments and preferred or optional features, when the computer program code is executed by a processing device.

A twelfth inventive aspect is a computer readable medium having stored thereon a computer program comprising computer program code for performing the functionality of the computerized payment service provider in the computerized method according to the first inventive aspect, including any or all of its embodiments and preferred or optional features, when the computer program code is executed by a processing device.

A thirteenth inventive aspect is a computer readable medium having stored thereon a computer program comprising computer program code for performing the functionality of the payer communication device in the computerized method according to the first inventive aspect, including any or all of its embodiments and preferred or optional features, when the computer program code is executed by a processing device.

A fourteenth inventive aspect is a computer readable medium having stored thereon a computer program comprising computer program code for performing the functionality of the payee communication device in the computerized method according to the first inventive aspect, including any or all of its embodiments and preferred or optional features, when the computer program code is executed by a processing device.

As used in this document, the term “short-range data communication” includes any form of proximity-based device-to-device communication, unidirectional or bidirectional. This includes radio-based short-range wireless data communication such as, for instance, Bluetooth, BLE (Bluetooth Low Energy), RFID, WLAN, WiFi, mesh communication or LTE Direct, without limitation. It also includes non-radio-based short-range wireless data communication such as, for instance, magnetic communication (such as NFC), audio communication, ultrasound communication, or optical communication (such as QR, barcode, IrDA).

As used in this document, the term “wide area network communication” (abbreviated as “WAN communication”) includes any form of data network communication with a party which may be remote (e.g. cloud-based), including cellular radio communication like W-CDMA, GSM, UTRAN, HSPA, LTE, LTE Advanced or 5G, possibly communicated as TCP/IP traffic, or via a WLAN (WiFi) access point, without limitation. Moreover, the terms “long-range data communication” and “broadband data communication” are considered as synonyms of “wide-area network communication”.

Expressions like “[entity] is configured for . . . [performing activity]” or “[entity] is configured to . . . [perform activity]” will include typical cases where a computerized entity (having one or more controllers, processing units, programmable circuitry, etc.) executes software or firmware installed in the computerized entity, wherein the execution occurs in order to perform the activity in question.

Other aspects, objectives, features and advantages of the inventive aspects will appear from the following detailed disclosure, from the attached dependent claims as well as from the drawings. Generally, all terms used in the claims are to be interpreted according to their ordinary meaning in the technical field, unless explicitly defined otherwise herein.

All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

FIG. 1 is a schematic diagram of a digital payment system for performing a digital payment by a payer to a payee according to an aspect of the invention.

FIG. 2A is a schematic flowchart diagram of a computerized method of performing a digital payment by a payer to a payee according to an aspect of the invention.

FIGS. 2B and 2C are schematic flowchart diagrams of embodiments of the computerized method of performing a digital payment.

FIG. 3 is a schematic block diagram of a communication device that may implement a payer communication device suitable for use in the digital payment system and computerized method.

FIG. 4 is a schematic block diagram of a communication device that may implement a payee communication device suitable for use in the digital payment system and computerized method.

FIG. 5 is a schematic illustration of a computer-readable medium in one exemplary embodiment, capable of storing a computer program product.

FIG. 6 is a sequence and signal diagram illustrating certain setup activities for generating and distributing digital certificates as well as onboarding of the payment service provider, the payer and the payer communication device in an embodiment of the digital payment system.

FIG. 7 is a sequence and signal diagram illustrating certain topup activities for increasing the balance of an account managed by the payment service provider and increasing the balance of a local digital wallet in the payer communication device while reserving funds in the account managed by the payment service provider, in an embodiment of the digital payment system.

FIGS. 8A and 8B are two parts of a sequence and signal diagram illustrating certain payment activities performed in order to make a digital payment in an embodiment of the digital payment system, with online payment being illustrated in FIG. 8A and offline payment being illustrated in FIG. 8B.

FIG. 9 is a sequence and signal diagram illustrating certain verification activities performed in order to verify a digital payment in an embodiment of the digital payment system.

FIG. 10 is a sequence and signal diagram illustrating certain settlement and related activities performed when settling a digital payment in an embodiment of the digital payment system.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like drawings references refer to like elements throughout, particularly such that an element being referred to as “ynn” in a second drawing is to be understood as the same as or the equivalent of an element being referred to as “xnn” in a first drawing, where x and y are single-digit numbers and nn is a double-digit number. When the same drawings reference is used for an element that appears in multiple drawings, such element is to be understood as being the same or at least equivalent throughout such multiple drawings. Elements illustrated as hatched boxes are generally to be seen as optional in the particular drawing in which they appear.

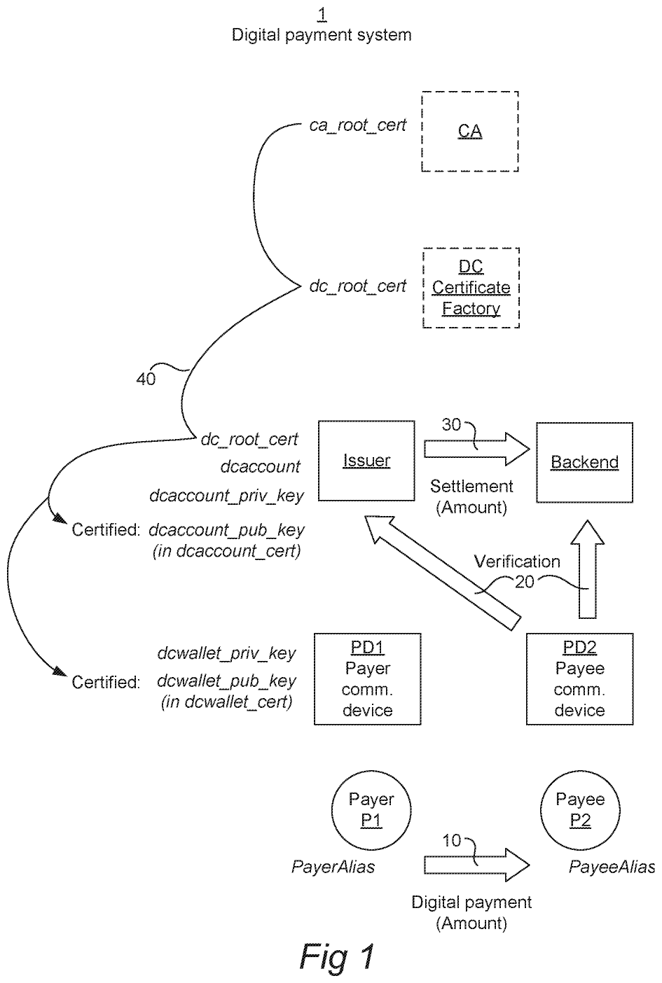

Overview FIG. 1 illustrates a digital payment system 1 for performing a digital payment in a desired amount, which is referred to as Amount, by a payer P1 to a payee P2. This is schematically indicated at 10 in FIG. 1.

The digital payment system 1 comprises a computerized payment service provider, referred to as Issuer and being a cloud-based computing resource. The digital payment system 1 further comprises a payer communication device PD1 for use by the payer P1, a payee communication device PD2 for use by the payee P2, and a computerized payment server function, referred to as Backend and being a cloud-based computing resource.

The digital payment system 1 allows for verification by the payee P2 of the digital payment. In typical embodiments, this involves interaction between the payee communication device PD2 and the computerized payment service provider Issuer or payment server function Backend. This is seen at 20 in FIG. 1.

After successful verification, the digital payment may be settled between the payment service provider Issuer and the payment server function Backend, as seen at 30 in FIG. 1.

The payer and the payee may typically be human users. However, it is also envisaged that one or both of the payer P1 and payee P2 may be automated machines or incarnations of artificial intelligence. The payer P1 is represented by an alias PayerAlias in the digital payment system 1, whereas the payee P2 is represented by an alias PayeeAlias. As will be explained in more detail in a later section of this document, actual knowledge of the true identity of the person having the alias PayerAlias of the payer P1 is not a mandatory requirement for performing the digital payment in some embodiments of the digital payment system 1. Similarly, actual knowledge of the true identity of the person having the alias PayeeAlias of the payee P2 is not a mandatory requirement for settlement of the digital payment in some embodiments of the digital payment system 1. Hence, the present invention offers personal integrity. The aliases may, for instance, be email addresses, social media accounts, etc.

Advantageously, trust and security are built into the digital payment system 1 by the use of digital certificates. An advantageous chain of certificates is indicated at 40 in FIG. 1. In addition, the digital payment system 1 preferably comprises an entity, DC Certificate Factory, for generating and certifying some of the digital certificates to be used in the system 1. Moreover, the digital payment system 1 preferably comprises a certificate authority CA which is in control of a root digital certificate ca root cert, by means of which the various other digital certificates in the system 1 can be authenticated (validated).

### Core Method/System and Embodiments Thereof

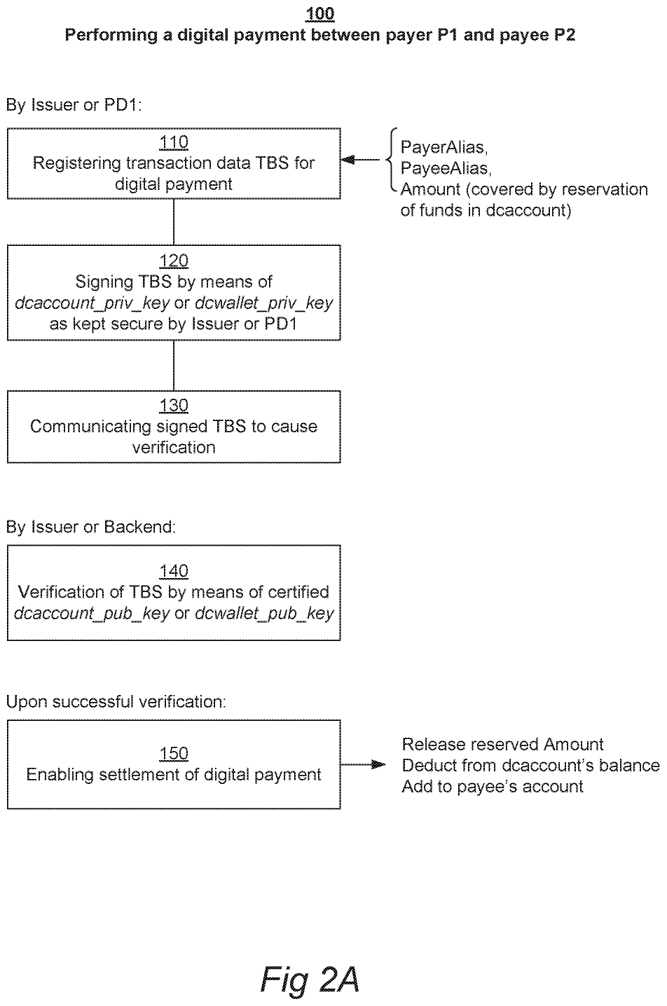

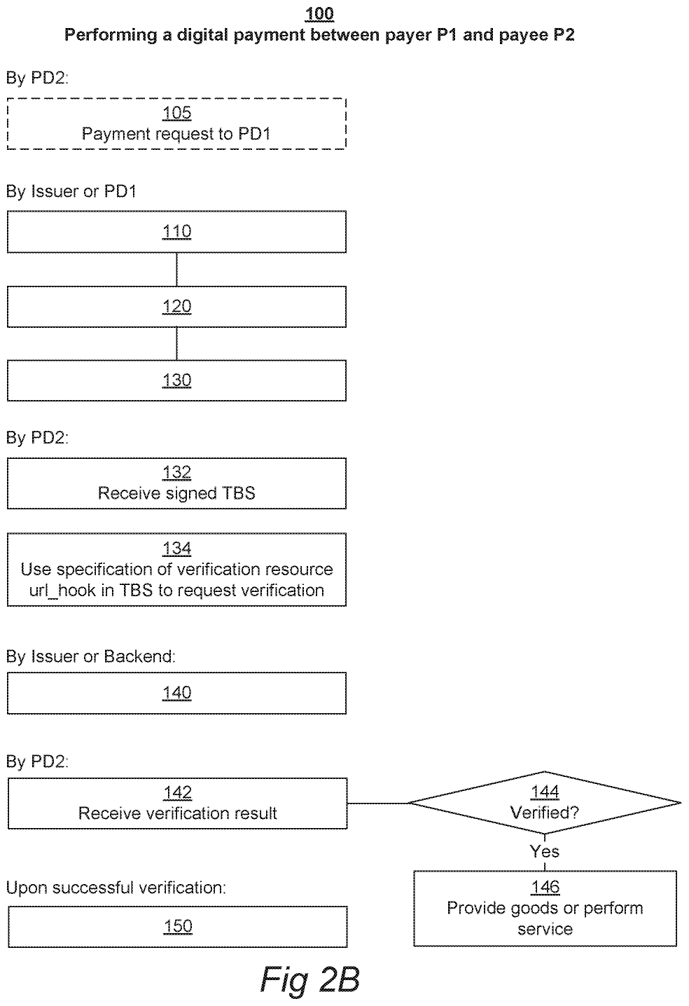

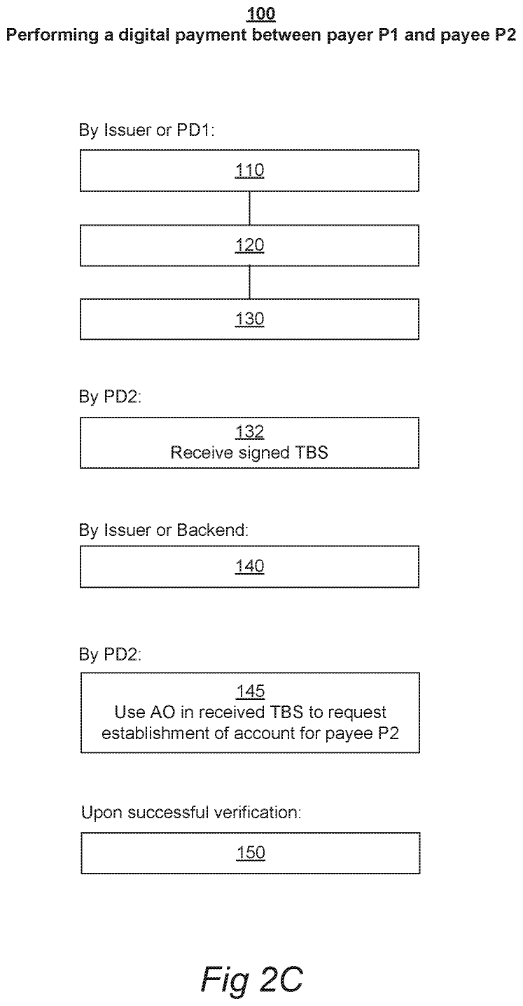

FIG. 2A illustrates a computerized method 100 of performing a digital payment by a payer to a payee, such as the digital payment 10 by the payer P1 to the payee P2 in the digital payment system 1 of FIG. 1. The main functionality of the computerized method 100 is as follows.

At 110, transaction data TBS is registered for the digital payment. The transaction data comprises the alias PayerAlias of the payer P1, the alias PayeeAlias of the payee P2, and a representation of the payment amount Amount which is covered by a reservation of funds in an account dcaccount managed by the payment service provider Issuer. The account dcaccount may be an account held by the payer P1, or it may be a common account for a plurality of payers served by the payment service provider Issuer. The representation of the payment amount Amount may typically be a numerical value, or a digital token associated with a certain value or property.

Then, at 120 in FIG. 2A, the transaction data TBS is signed by means of a private cryptographic key which is kept secure by the payment service provider Issuer or payer communication device PD1, typically by storing it in a secure local storage, or by storing it securely in and by another device or entity with which the payment service provider Issuer or payer communication device PD1 has a strong and reliable association. The signature of the transaction data TBS is referred to as P in this document.

In some of the illustrated embodiments of the invention, the private crypto-graphic key is referred to as dcaccount_priv_key or dcwallet_priv_key. As can be seen, dcaccount_priv_key is kept secure and used for signing purposes by the payment service provider Issuer, whereas dcwallet_priv_key is kept secure and used for signing purposes by the payer communication device PD1.

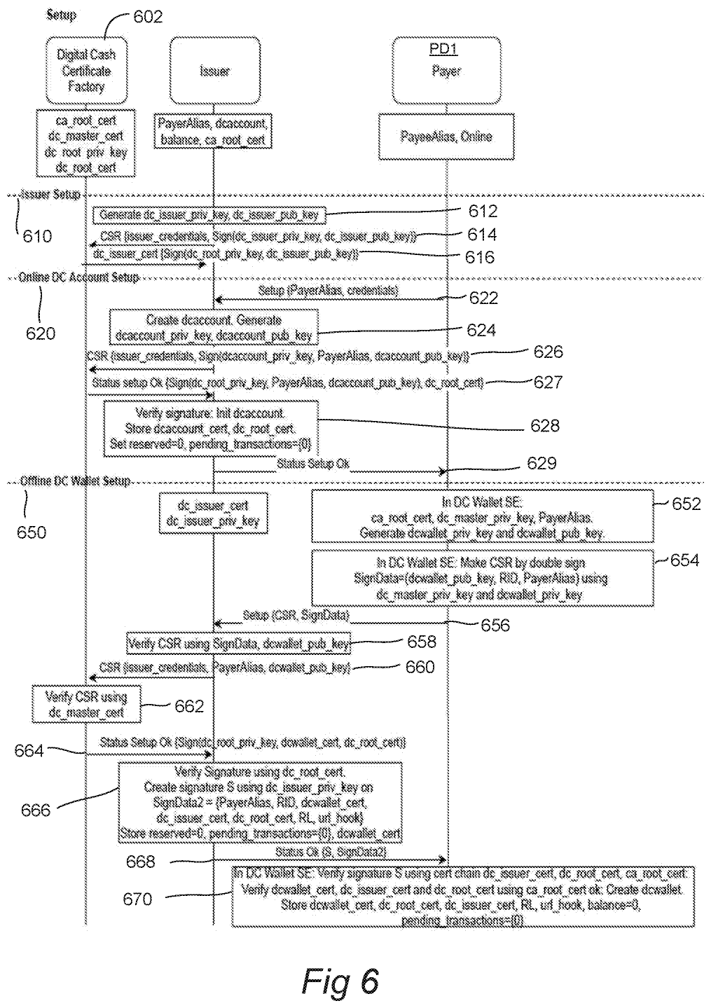

Details of the use of digital certificates in the present invention and its embodiments will appear to the skilled person from the detailed information provided particularly in FIGS. 6-10. It is, however, worth mentioning already now that the public cryptographic key dcaccount_pub_key or dcwallet_pub_key may advantageously be included in a digital certificate dcaccount_cert or dcwallet_cert, which can be authenticated, directly or indirectly, by means of the root digital certificate ca_root_cert of the certificate authority CA. For reasons of trust and integrity, the certificate authority CA is independent from the entities of the digital payment system 1. Advantageously, the digital certificate dcaccount_cert or dcwallet_cert has been signed by the payment service provider Issuer using a private key associated with an intermediate digital certificate dc_root_cert, wherein the intermediate digital certificate can be authenticated in turn by means of the root digital certificate ca_root_cert.

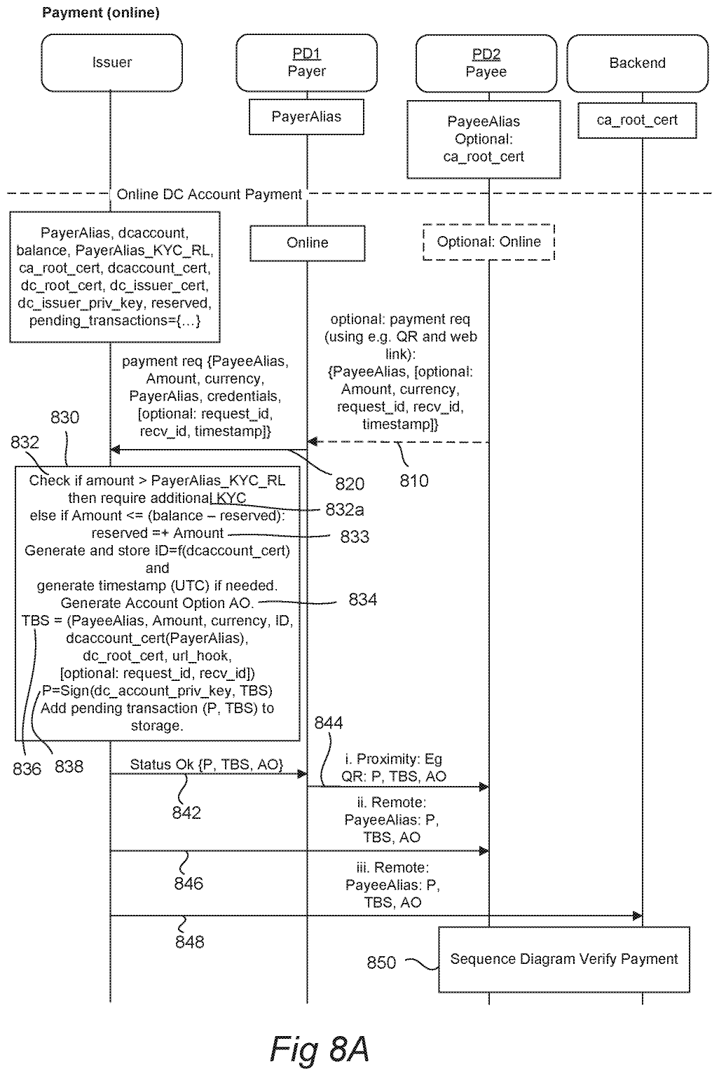

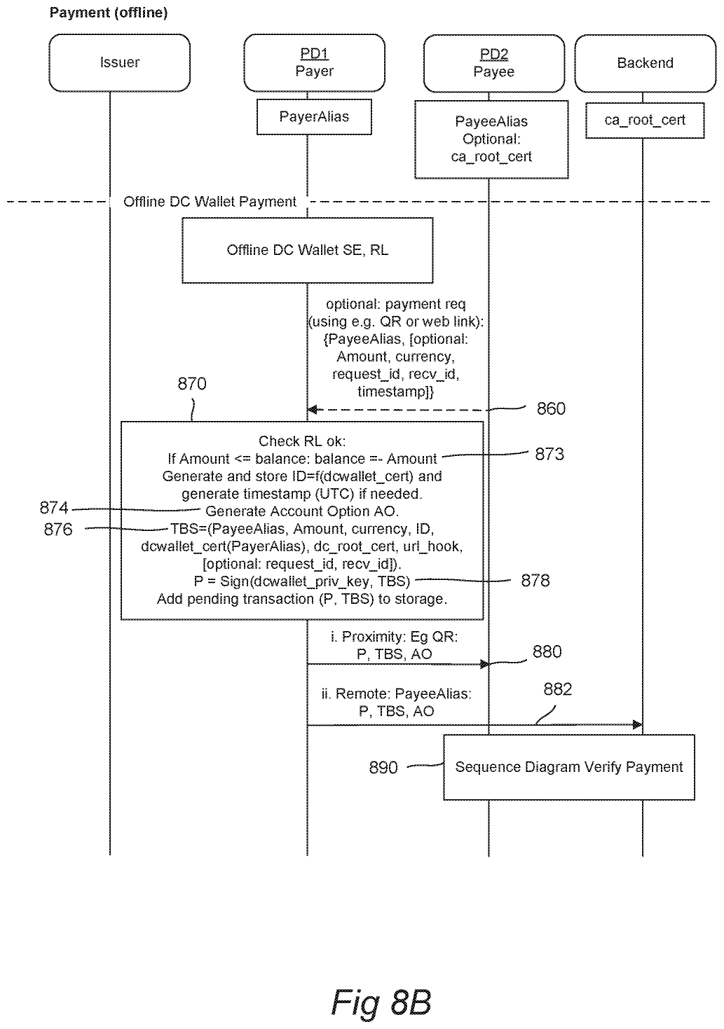

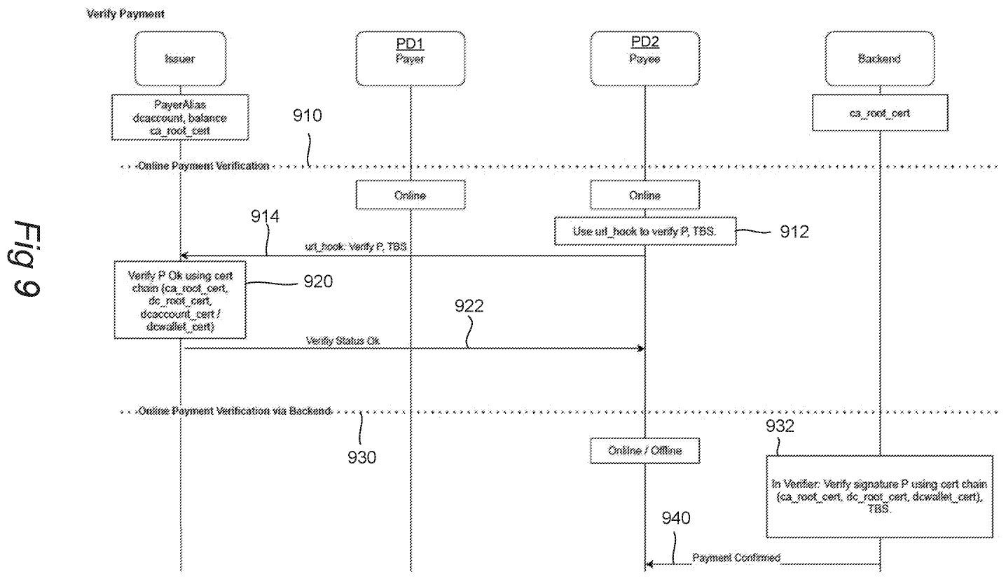

Embodiments of the transaction data registering and signing stages 110 and 120 will be seen in FIG. 8A-B; see for instance steps 838-840 and 876-878, respectively. As can be seen in FIG. 2B, the computerized method 100 may further comprise an initial step 105 in which the payee communication device PD2 provides at least some of the transaction data TBS for the digital payment to the payer communication device PD1. As can be seen at 810 in FIG. 8A, this can for instance be made by presenting a QR code for reading by the payer communication device PD1, wherein the (full or partial) transaction data TBS may be encoded into the QR code, Alternatively, the QR code may contain a uniform resource locator directing the payer communication device PD1 to a web resource from which the (full or partial) transaction data TBS can be retrieved. Of course, the step 105/810 may be performed by any suitable short-range data communication or wide area network communication between the payee communication device PD2 and the payer communication device PD1.

Further on, at 130 in FIG. 2A, the signed transaction data P, TBS is communicated (cf. 842-848 and 880-882, respectively, in FIGS. 8A-B) to another entity to enable (and ultimately cause) verification 140 at the payment service provider Issuer or payment server function Backend by means of a certified public cryptographic key, dcaccount_pub_key or dcwallet_pub_key, which corresponds to the private cryptographic key.

Following successful verification, settlement of the digital payment is enabled at 150 by releasing the payment amount Amount from the reservation of funds in dcaccount, deducting funds from a balance of dcaccount and adding funds to an account associated with the payee P2.

The deduction and addition correspond to the payment amount Amount. In some embodiments, the deduction and the addition are equal to the payment amount Amount (i.e., the payment amount Amount is subtracted from the balance of dcaccount and is added to the balance of the account associated with the payee P2). In some embodiments, a fee may be charged to either or both of these accounts, wherein the deduction and/or addition may not be exactly identical to the payment amount Amount. In some embodiments, a currency conversion is done at the payer side or at the payee side.

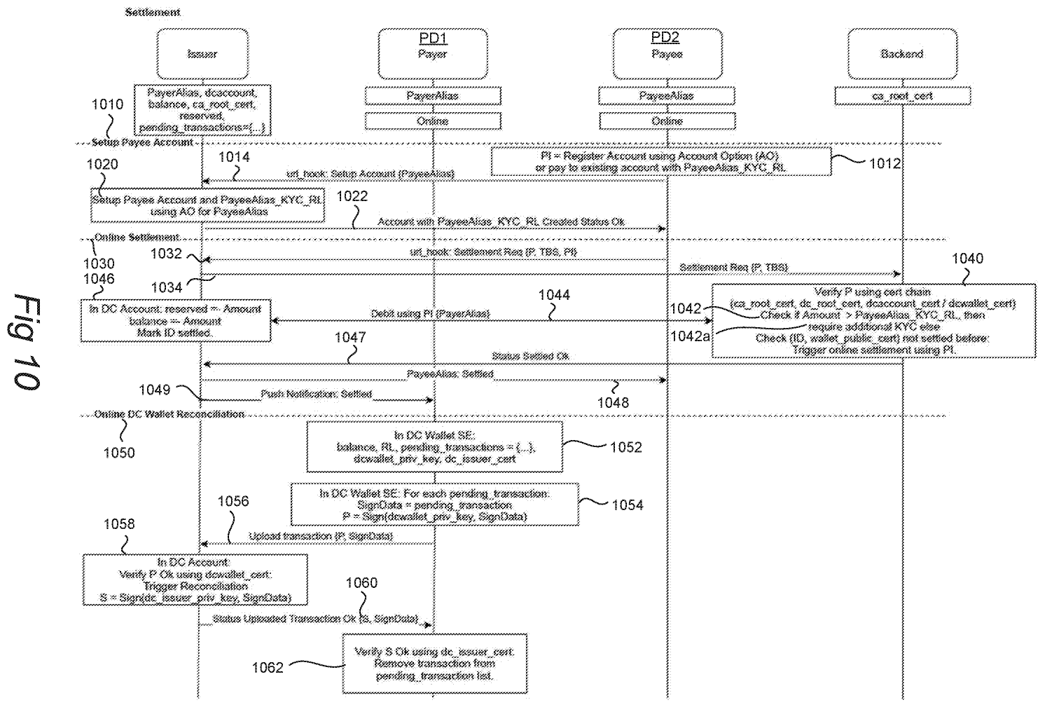

Embodiments of the verification stage 140 will be seen in FIG. 9, whereas embodiments of the settlement stage 150 will be seen in FIG. 10.

The payee P2 is given the opportunity to verify the validity of the digital payment as follows. As can be seen in FIG. 2B and also in FIGS. 8-10, the signed transaction data P, TBS includes a specification of a verification resource url_hook. The payee communication device PD2 will receive the signed transaction data P, TBS at 132, and use (cf. 912 in FIG. 9) the specification of the verification resource url_hook to make a verification request at 134 (cf. 914 in FIG. 9) at the payment service provider Issuer or payment server function Backend, reachable through the specification of the verification resource url_hook.

Accordingly, even though the payee P2 may lack any detailed information of the identity, credibility and solidity of the payer P1, the payee P2 may still conveniently verify the received digital payment by using the verification resource url_hook. This is particularly advantageous in situations when the payer P1 and payee P2 are involved in a transaction according to which the payee P2 is to provide a goods or perform a service in exchange of an economic compensation (i.e., the payment amount) from the payer P1. To this end, the payee communication device PD2 may receive a verification result at 142 in FIG. 2B (also see 922 in FIG. 9) from the payment service provider Issuer or payment server function Backend. Conditionally upon a successful verification being indicated by the verification result and checked at 144, the payee communication device PD2 may safely provide the goods or perform the service at 146.

The specification of the verification resource url_hook may advantageously be a uniform resource locator. In advantageous embodiments, the signed transaction data P, TBS is communicated at 130 to the payee communication device PD2 in a message (cf. 842-848 in FIG. 8A) which begins with the uniform resource locator url_hook. This will allow invocation of a web browser application (cf. 411 in FIG. 4) in the payee communication device PD2 (cf. 400 in FIG. 4) to make the verification request 134; 912 over a browser-to-browser connection with the payment service provider Issuer or payment server function Backend. Hence, in such embodiments, virtually any standard communication device may be used for the payee communication device PD2, without requiring installation or configuration of special software (it is recalled that a web browser application is typically included in the standard software installation with which any communication device is shipped).

After having received the verification result at 142 from the payment service provider Issuer or payment server function Backend, and having verified at 144 that the verification result indicates a successful verification 144, the payee communication device PD2 may make a settlement request 150 at the payment service provider Issuer or payment server function Backend. Also see 1032 in FIG. 10.

In other embodiments, however, the payment service provider Issuer or payment server function Backend may be the one causing settlement 150 of the digital payment upon successful verification 140 of the signed transaction data P, TBS. Hence, once the payment service provider Issuer or payment server function Backend has verified the digital payment, it may make an initiative by itself to trigger settlement 150 of the digital payment.

After settlement 150 of the digital payment, the payment service provider Issuer or payment server function Backend may send a payment confirmation message (cf. 940 in FIG. 9) to the payee communication device PD2.

As can be understood from the above, execution of the method 100 does not necessarily require preparatory interaction between the payee communication device PD2 and the other entities of the digital payment system 1 in other to enable the payee P2 to receive a digital payment. In other words, no particular onboarding actions for the payee P2 or payee communication device PD2 will have to be performed in advance of the particular digital payment.

To this end, one advantageous embodiment is illustrated in FIG. 2C. In the actual communication stage 130, the payee P2 is offered to onboard the payment services provided by the payment service provider Issuer. This offering is referred to as account option in the present disclosure. Accordingly, in the embodiment of FIG. 2C, the payee communication device PD2 is configured for receiving 132 the signed transaction data P, TBS, wherein account option data AO is included therein or enclosed therewith. Furthermore, the payee communication device PD2 is configured for using the account option data AO to make a request 135 for establishment (cf. 1020 in FIG. 10) of an account associated with the payee P2 prior to settlement 150 of the digital payment.

Embodiments of the digital payment system 1 and computerized method 100 are particularly versatile in that they offer not only digital payments that are carried out online (meaning that the payer communication device is able to communicate with cloud-based computing resources (including Issuer and/or Backend) by wide area network communication to carry out the digital payment momentarily), but in addition also digital payments that are carried out offline. By offline is meant that the payer communication device PD1 is, for the time being, unable to communicate with cloud-based computing resources by wide area network communication. Nevertheless, when being offline the payer communication device PD1 is able to communicate with the payee communication device PD2 by short-range data communication to perform the digital payment.

Embodiments of the computerized method 100 will perform an online digital payment in the following way. The payer communication device PD1 makes a payment request (cf. 820 in FIG. 8A) at the payment service provider Issuer, wherein the payment request includes at least some of the transaction data TBS for the digital payment. The payment service provider Issuer registers the transaction data TBS at 110 in FIG. 2A (cf. 836 in FIG. 8A), wherein the payment amount Amount is reserved (cf. 833 in FIG. 8A) in said managed account dcaccount. The payment service provider Issuer signs the transaction data at 120 in FIG. 2A (cf 838 in FIG. 8A) by means of the private cryptographic key dcaccount_priv_key as kept secure by the payment service provider. The payment service provider Issuer communicates the signed transaction data P, TBS at 130 in FIG. 2A to one of:
the payer communication device PD1 using wide area network communication (cf. 842 in FIG. 8A), for forwarding by the payer communication device to the payee communication device PD2 using short-range data communication (cf. 844 in FIG. 8A) or wide area network communication, and
the payee communication device PD2 using wide area network communication (cf 846 in FIG. 8A).
(In alternative embodiments, the payment service provider Issuer may instead communicate the signed transaction data P, TBS at 130 in FIG. 2A to the payment server function Backend using wide area network communication, cf. 848 in FIG. 8A.)

Embodiments of the computerized method 100 perform an offline digital payment in the following way. The payer communication device PD1 comprises a digital wallet DC Wallet in local storage (cf. TEE in FIG. 4). The digital wallet DC Wallet comprises a local balance, Balance, having been reserved in the account dcaccount managed by the payment service provider Issuer. The payer communication device registers the transaction data TBS for the digital payment at 110 in FIG. 2A (cf. 876 in FIG. 8B), wherein the local balance of the digital wallet is reduced (cf. 873 in FIG. 8B) by the payment amount Amount. The payer communication device PD1 signs the transaction data TBS at 120 in FIG. 2A (cf. 878 in FIG. 8B) by means of the private cryptographic key dcwallet_priv_key as kept secure by the payer communication device PD1. The payer communication device PD1 communicates the signed transaction data P, TBS at 120 in FIG. 2A either to the payee communication device PD2 using short-range data communication (cf. 880 in FIG. 8B) or wide area network communication, or to the payment server function Backend using wide area network communication (cf. 882 in FIG. 8B).

It has already been mentioned above that the present invention may provide advantages in terms of personal integrity. It is recalled that actual knowledge of the true identities of the persons having the alias PayerAlias of the payer P1 and the alias PayeeAlias of the payee P2, respectively, is not a mandatory requirement for performing the digital payment in some embodiments of the digital payment system 1.

Some embodiments of the invention offer a further refined and balanced approach to personal integrity by actual knowledge of the true identity only when the digital payment exceeds one or more threshold criteria. These threshold criteria may, for instance, include constraints on one or more of the following: payment amount, payer location, payee location, type of payment, intended payment sender, and intended payment receiver.

To this end, at the stage 110 of registering the transaction data TBS for the digital payment, the payment service provider Issuer may be configured for checking (cf. 832 in FIG. 8B) whether the payment amount Amount falls outside of the boundaries of a payment limit PayerAlias_KYC_RL for the payer P1, and, if so requesting (cf. 832a in FIG. 8B) further information KYC (“Know Your Customer”) about the payer PD1 (in addition to the alias of the payer PayerAlias). Moreover, at the stage 150 of settlement of the digital payment, the computerized payment server function Backend may be configured for checking (cf. 1042 in FIG. 10) whether the payment amount Amount falls outside of the boundaries of a payment limit PayeeAlias_KYC_RL for the payee P2 and, if so, requesting (cf. 1052a in FIG. 10) further information KYC about the payee PD2 (in addition to the alias of the payee PayeeAlias).

### Implementation Examples—Devices

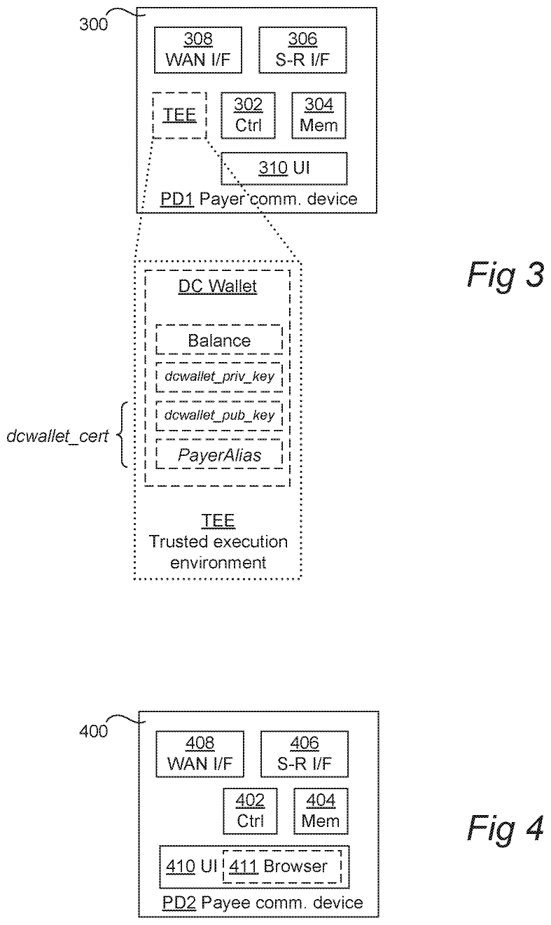

Reference is now being made to FIG. 3 and the communication device 300 illustrated therein. The communication device 300 may implement a payer communication device, like the aforementioned PD1, suitable for use in the digital payment system 1 and computerized method 100. To this end, the communication device 300 comprises a processing device 302, local storage including a memory 304, a short-range data communication interface 306, a wide area network communication interface 308 and a user interface 310.

The processing device 302 acts as a controller of the communication device 300 and may be implemented in any known controller technology, including but not limited to microcontroller, processor (e.g. PLC, CPU, DSP), FPGA, ASIC or any other suitable digital and/or analog circuitry capable of performing the intended functionality.

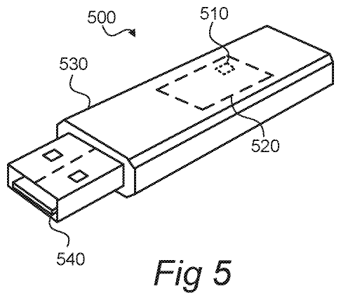

The memory 304 may be implemented in any known memory technology, including but not limited to ROM, RAM, SRAM, DRAM, CMOS, FLASH, DDR, SDRAM or some other memory technology. In some embodiments, the memory or parts thereof may be integrated with or internal to the processing device 302. The memory may store program instruction for execution by the processing device 302 (also see the description of FIG. 5 below), as well as temporary and permanent data for use by the processing device 302.

The short-range data communication interface 306 may be configured for Bluetooth communication, or any other radio-based short-range wireless data communication such as, for instance, Bluetooth Low Energy, RFID, WLAN, WiFi, mesh communication or LTE Direct, without limitation, or any non-radio-based short-range wireless data communication such as, for instance, magnetic communication (such as NFC), (ultra)sound communication, or optical communication (such as IrDA) without limitation. In some embodiments, the short-range data communication interface 306 comprises equipment and functionality for presenting or scanning a QR code.

The wide area network communication interface 308 may be configured for wide area network communication compliant with, for instance, one or more of W-CDMA, GSM, UTRAN, HSPA, LTE, LTE Advanced or 5G, and TCP/IP, and/or WLAN (WiFi), without limitation.

The user interface 310 may comprise an input device and a presentation device, as is generally known per se. In some embodiments, the input device and the presentation device are constituted by one common physical device, such as for instance a touch screen (touch-sensitive display screen), implemented in for instance resistive touch technology, surface capacitive technology, projected capacitive technology, surface acoustic wave technology or infrared technology.

The communication device 300 may further comprise a trusted execution environment TEE, such as a secure element, i.e. a tamper-resistant hardware or virtual platform. In the latter case, the trusted execution environment TEE may be implemented in software and may reside in the local storage or even the memory 304. The trusted execution environment TEE is capable of securely hosting applications and storing confidential and cryptographic data and therefore provides a trusted environment for execution of such applications, a.k.a. secure runtime. Advantageously, some of the data and functionality in embodiments of the invention may be stored in and performed by the trusted execution environment TEE, for instance those that have to do with the local digital wallet DC Wallet in the payer communication device PD1.

The communication device 300 may hence be configured to perform the functionality of the payer communication device PD1 as defined in and described above for the method 100 and any or all of its embodiments. The payer communication device PD1 may thus be implemented by the communication device 300 in the form of, for instance, a mobile communication device, a mobile phone, a smart phone, a tablet computer, a personal digital assistant, a portable computer, smart glasses, a smart wearable, a smart watch, a smart bracelet, a smart card or a smart chip.

FIG. 4 illustrates a communication device 400 which may implement a payee communication device, like the aforementioned PD2, suitable for use in the digital payment system 1 and computerized method 100. To this end, the communication device 400 comprises a processing device 402, local storage including a memory 404, a short-range data communication interface 406, a wide area network communication interface 408 and a user interface 410.

The processing device 402 acts as a controller of the communication device 400 and may be implemented in much the same way as the processing device 302 referred to above. The memory 404 may be implemented in much the same way as the memory 404 referred to above and may store program instruction for execution by the processing device 402 (also see the description of FIG. 5 below), as well as temporary and permanent data for use by the processing device 402.

The short-range data communication interface 406 and the wide area network communication interface 408 may be implemented in much the same way as the short-range data communication interface 306 and the wide area network communication interface 308 referred to above. The same may apply to the user interface 410 with respect to the user interface 310. As mentioned above, embodiments of the communication device 400 comprises a web browser application 411, being accessible via the user interface 410.

The communication device 400 may hence be configured to perform the functionality of the payee communication device PD2 as defined in and described above for the method 100 and any or all of its embodiments. The payee communication device PD2 may thus be implemented by the communication device 400 in the form of, for instance, a mobile communication device, a mobile phone, a smart phone, a tablet computer, a personal digital assistant, a portable computer, smart glasses, a smart watch, a smart card, a smart bracelet, a smart wearable, a payment terminal, a service terminal, a point-of-sales terminal, a checkout counter, a delivery pickup point, a vending machine, a ticket machine, a dispensing machine, or an access control system.

FIG. 5 is a schematic illustration of a computer-readable medium 500 in one exemplary embodiment, capable of storing a computer program product 510. The computer-readable medium 500 in the disclosed embodiment is a portable memory device, such as a Universal Serial Bus (USB) stick. The computer-readable medium 500 may however be embodied in various other ways instead, as is well-known per se to the skilled person. The portable memory device 500 comprises a housing 530 having an interface, such as a connector 540, and a memory chip 520. In the disclosed embodiment, the memory chip 520 is a flash memory, i.e. a non-volatile data storage that can be electrically erased and re-programmed. The memory chip 520 stores the computer program product 510 which is programmed with computer program code (instructions) that when loaded into a processing device, such as a CPU, will perform any of the functionalities listed in the next paragraph. The processing device may, for instance, be the aforementioned processing device 302 or 402. The portable memory device 500 is arranged to be connected to and read by a reading device for loading the instructions into the processing device. It should be noted that a computer-readable medium can also be other media such as compact discs, digital video discs, hard drives or other memory technologies commonly used. The computer program code (instructions) can also be downloaded from the computer-readable medium via a wireless interface to be loaded into the processing device.

In one embodiment, therefore, the computer-readable medium 500/computer program product 510 comprises computer program code for performing the functionality of the payer communication device PD1 in the method 100 as described herein when the computer program code is executed by the processing device. In another embodiment, the computer-readable medium 500/computer program product 510 comprises computer program code for performing the functionality of the payee communication device PD2 in the method 100 as described herein when the computer program code is executed by the processing device. In still other embodiments, the computer-readable medium 500/computer program product 510 comprises computer program code for performing the functionality of the computerized payment server function Backend or the computerized payment service provider Issuer in the method 100 as described herein when the computer program code is executed by the processing device.

### Detailed Implementation Examples—Method and System

For further details of embodiments of the invention, reference is made to the remainder of the drawings, i.e. FIGS. 6-10. By virtue of their high degree of detailed information, these drawings are generally believed to be fully comprehensible by the skilled person being guided by the general disclosure given above with reference to FIGS. 1-5. Nevertheless, some comments to FIGS. 6-10 will be given below.

FIG. 6 illustrates certain setup activities for generating and distributing digital certificates as well as onboarding of the payment service provider Issuer, the payer P1 and the payer communication device PD1 in an embodiment of the digital payment system 1. Setting up of the Issuer is shown at block 610. Here, the Issuer generates a pair of cryptographic keys dc_issuer_priv_key and dc_issuer_pub_key, sends a certificate signing request CSR at 614 to the DC Certificate Factory seen at 602, and in return receives a signed digital certificate dc_issuer_cert at 616.

Block 620 in FIG. 6 then describes how the payer P1 requests setup of dcaccount by submitting the PayerAlias and certain credentials at 622 to the Issuer. Through steps 626-628, the block concludes by informing PD1 at 629.

A corresponding block 650 describes how the payer P1 requests setup of DC Wallet for use with the digital payment system 1. The procedure involves the previously generated dc_issuer_cert.

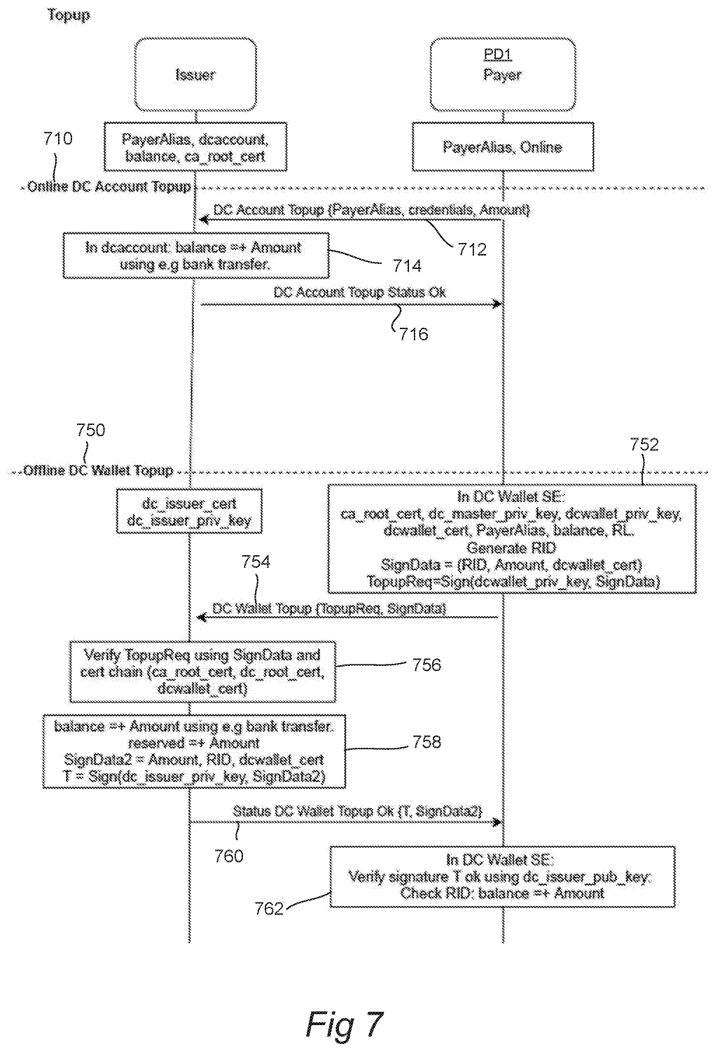

FIG. 7 illustrates certain topup activities for increasing the balance of the account dcaccount managed by the payment service provider Issuer (block 710), and the balance of the local digital wallet DC Wallet managed by the payer communication device PD1 (block 750). The topup involves transferring of funds for the payer P1 from an external source to the dcaccount or DC Wallet inside the digital payment system 1. The external source may, for instance, be a bank or other financial institution where the payer P1 has an account from which the funds are transferred. For instance, see step 712 where the payer communication device PD1 sends a DC Account Topup request to the payment service provider Issuer, step 714 where the payment service provider Issuer increases the balance of the account dcaccount by transferring funds from said bank or other financial institution, and step 716 where the payment service provider Issuer sends 15 a DC Account Topup Status confirmation to the payer communication device PD1.

FIGS. 8A-B illustrates certain payment activities performed for the digital payment and has already been referred to several times in the foregoing general disclosure. It is recalled that FIG. 8A illustrates online payment whereas FIG. 8B illustrates offline payment. Particularly noticeable parts of FIG. 8A are the block 830 where the registration and signing of transaction data TBS takes place for an online payment, the communication at 844-850 of the signed transaction data TBS for the online payment, and the subsequent verification at 850. Particularly noticeable parts of FIG. 8B are the block 870 where the registration and signing of transaction data TBS takes place for an offline payment, the communication at 880-882 of the signed transaction data TBS for the offline payment, and the subsequent verification at 890.

For the offline payment functionality, the DC Wallet has a risk limit profile, RL. The payer communication device PD1 is configured to verify that the desired digital payment complies with the risk limit profile RL. The risk limit profile RL may be set by the payment service provider Issuer (cf. 666 in FIG. 6) and may, for instance, define one or more of the following constraints:
a total spending limit for digital payments that have not yet been settled;
a maximum payment amount for each digital payment;
a maximum accumulated payment amount for digital payments, and/or a maximum number of digital payments, performable until communicating the contents of a transaction log of offline payments to the payment service provider Issuer;
a maximum accumulated payment amount for digital payments performable during a certain time (such as a day, week, month, etc.);
a maximum number of digital payments performable during a certain time (such as a day, week, month, etc.);
a definition (e.g. aliases) of payment receivers that the payer P1 is allowed to make digital payments to; and
a definition (e.g. aliases) of payment receivers that the payer P1 is not allowed to make digital payments to.

FIG. 9 illustrates certain verification activities performed in order to verify the digital payment and has already been referred to in the foregoing general disclosure. FIG. 9 provides details of the verifications made at 850 and 890 in FIGS. 8A and 8B, respectively. Note that the verification involves use of a chain of certificates that involves the root digital certificate ca_root_cert of the certificate authority CA, the intermediate digital certificate dc_root_cert and the digital certificate dcaccount_cert or dcwallet_cert.

As can be further seen in FIGS. 8A and 9, the present invention includes an embodiment where the computerized payment server function Backend receives (at 848 in FIG. 8A) the signed transaction data P, TBS from the computerized payment service provider Issuer. The computerized payment server function Backend verifies (see 890 in FIG. 8A and 932 in FIG. 9) the signed transaction data P, TBS, and communicates (at 940 in FIG. 9) a verification result to the payee communication device PD2. The payee communication device PD2 receives the verification result, as can be seen in FIG. 9. Conditionally upon a successful verification being indicated by the verification result, the payee communication device PD2 may provide a goods or perform a service associated with the digital payment. As an alternative to the embodiment described above with reference to FIG. 2B, this approach will hence require less involvement by the payee communication device PD2 (it neither has to receive the signed transaction data P, TBS, nor use an included verification resource url_hook to make a verification request at the payment service provider Issuer or payment server function Backend). Nevertheless, the signed transaction data P, TBS can be verified by the payment server function Backend on behalf of the payee communication device PD2, thus enabling the latter to make a trusted decision as to whether or not to provide a goods or perform a service associated with the digital payment (corresponding to the functionality in steps 142-146 of FIG. 2B).

FIG. 10 illustrates certain settlement and related activities performed when settling a digital payment and has already been referred to in the foregoing general disclosure. Note the setting up in block 1010 of a payee account using the account option (AO) feature. If the payee P2 already has an account at the payment service provider Issuer, the payment can be settled to such an account instead (see 1012). The KYC mechanisms have already been described above. An online settlement, block 1030, involves verification using the same chain of certificates as has been described above. Measures are taken to keep track of which transactions have already been settled in order to avoid double spending. This may, for instance, involve checking a timestamp and/or an identity which have/has been signed into the transaction data TBS at the payment stage; see timestamp (UTC) and ID in block 830 of FIG. 8A and block 870 of FIG. 8B. In some embodiments, the ID can be checked already at the verification stage, e.g. by the Issuer in block 920 of FIG. 9. Block 1050 illustrates reconciliation of the DC Wallet when the payer communication device PD1 has regained access to the cloud-based payment service provider Issuer by wide area network communication.

### CONCLUDING REMARKS

The cloud-based computing resources as referred to in this document may for instance be implemented as one or more physical server computers or computer systems, or one or more distributed networks of computing resources.

The payment service provider Issuer may, for instance be an issuing bank or other financial institution. The computerized payment server function Backend may, for instance be a payment network switch, or an acquiring bank or other financial institution. In a closed-loop system, the payment service provider Issuer may implement also the payment server function Backend. In other words, the functionality of the payment service provider Issuer and the functionality of the payment server function Backend may be implemented by the same cloud-based computing resource.

The account dcaccount being “managed by the payment service provider”, as referred to in this document, is to be understood in a broad sense to include embodiments where the account dcaccount is implemented at the payment service provider Issuer (at which the payer P1 is a customer or client), as well as embodiments where the account dcaccount is controlled by the payer P1 and implemented at an issuing bank operably accessible to the payment service provider Issuer. The payer P1 will be a customer or client at the issuing bank, and the issuing bank may typically be the “bank or other financial institution” referred to in conjunction with the topup in step 714 of FIG. 7.

The digital certificates referred to in this document may, for instance, be DER-encoded X.509-based certificates which comprise public cryptographic keys for the respective entities of the digital payment system 1, as described above.

When reference in this document is being made to a private cryptographic key which is associated with a particular digital certificate, this includes a case where the particular digital certificate comprises a public cryptographic key, and where the private (secure) cryptographic key and the public cryptographic key together constitute a cryptographic key pair as is generally known for asymmetric data encryption and decryption.

Any currencies referred to in this document may be official monetary currencies like, for instance, SEK, EUR, USD, etc., digital currencies like CBDC (Central Bank Digital Currency) or crypto currencies (block chain-based distributed ledger technology), or combinations thereof.

Finally, it should be clear to the skilled reader of this disclosure that the present invention offers digital payments with privacy, interoperability and instant verification. Easier onboarding and interoperability are beneficial for many payment service providers, and most CBDC implementations have privacy as a key requirement. Instant verification is made possible by a two-step payment process, adding value to complex open-loop payments that may experience delays in responses at the moment-of-payment involving open banking, international remittances and CBDC.

The present invention makes it much easier to onboard new users as there are no pre-requisites to receive payments, making it just as easy to receive a digital payment as it is to receive physical cash. New users verify payments using a link integrated with the digital payment. There may also be a link where user may opt for opening new accounts with the payment service provider to settle and make other digital payments. Easy onboarding is expected to be desirable by commercial payment applications as well as CBDC implementations.

Allowing users to enjoy the present invention without prerequisites will open the possibility to support privacy, a key feature for CBDC in countries planning to preserve payment integrity when cash goes digital. Regulators or payment service providers may establish limits for digital transactions with privacy. To prevent money laundering, the payment service provider would be obliged to request more knowledge of the user if limits are exceeded. This mirrors current procedures depositing physical cash.

Alternative inventive aspects are defined in the following numbered clauses.

I. A computerized method (100) of performing a digital payment by a payer (P1) to a payee (P2) in a digital payment system (1) which comprises at least the following entities: a computerized payment service provider (Issuer), a payer communication device (PD1) for use by the payer, a payee communication device (PD2) for use by the payee, and a computerized payment server function (Backend), wherein the computerized method (100) involves:
registering (110) transaction data (TBS) for the digital payment, the transaction data comprising an alias (PayerAlias) of the payer, an alias (PayeeAlias) of the payee, and a representation of a payment amount (Amount) which is covered by a reservation of funds in an account (dcaccount) managed by the payment service provider;
signing (120) of the transaction data by means of a private cryptographic key (dcaccount_priv_key; dcwallet_priv_key) kept secure by the payment service provider or payer communication device;
communicating (130) the signed transaction data (P, TBS) to cause verification (140) at the payment service provider or payment server function by means of a certified public cryptographic key (dcaccount_pub_key; dcwallet_pub_key) corresponding to the private cryptographic key; and
subject to successful verification, enabling settlement (150) of the digital payment by releasing the payment amount from the reservation of funds, deducting funds from a balance of said account and adding funds to an account associated with the payee, the deduction and addition corresponding to the payment amount.

II. The computerized method (100) according to clause I, further comprising the payee communication device (PD2):
receiving (132) the signed transaction data (P, TBS), wherein the signed transaction data includes a specification of a verification resource (url_hook); and
using (912) the received data to make a verification request (134; 914) at the payment service provider (Issuer) or payment server function (Backend).

III. The computerized method (100) according to clause II, further comprising the payee communication device (PD2):
receiving (142) a verification result (922) from the payment service provider (Issuer) or payment server function (Backend); and
conditionally upon a successful verification (144) being indicated by the verification result, providing a goods or performing a service (146) associated with the digital payment.

IV. The computerized method (100) according to clause II or III, further comprising the payee communication device (PD2):
receiving (142) a verification result from the payment service provider (Issuer) or payment server function (Backend); and
conditionally upon a successful verification (144) being indicated by the verification result, making a settlement request (150; 1032) at the payment service provider (Issuer) or payment server function (Backend).

V. The computerized method (100) according to clause I, wherein upon successful verification (140) of the signed transaction data (P, TBS), the payment service provider (Issuer) or payment server function (Backend) causes settlement (150) of the digital payment.

VI. The computerized method (100) according to clause IV or V, wherein after settlement (150) of the digital payment, the payment service provider (Issuer) or payment server function (Backend) sends a payment confirmation message (940) to the payee communication device (PD2).

VII. The computerized method (100) according to any preceding clause, wherein execution of the method requires no preparatory interaction between the payee communication device (PD2) and the other entities of the digital payment system (1).

VIII. The computerized method (100) according to any preceding clause, further comprising the payee communication device (PD2):
receiving (132) the signed transaction data (P, TBS), wherein account option data (AO) is included therein or enclosed therewith; and
using the account option data to make a request (135) for establishment (1020) of said account associated with the payee (P2) prior to settlement (150) of the digital payment.

IX. The computerized method (100) according to any of clauses II-VIII, further comprising an initial step (105; 810) of the payee communication device (PD2) providing at least some of the transaction data (TBS) for the digital payment to the payer communication device (PD1).

X. The computerized method (100) according to any preceding clause, wherein:
the payer communication device (PD1) comprises a digital wallet (DC Wallet) in local storage (TEE);
the digital wallet (DC Wallet) comprises a local balance (Balance) having been reserved in the account (dcaccount) managed by the payment service provider (Issuer);
the payer communication device registers (110; 876) the transaction data (TBS) for the digital payment, wherein the local balance of the digital wallet is reduced (873) by the payment amount (Amount);
the payer communication device signs (120; 878) the transaction data by means of the private cryptographic key (dcwallet_priv_key) as kept secure by the payer communication device; and
the payer communication device communicates (130) the signed transaction data (P, TBS) either to the payee communication device (PD2) using short-range data communication (880) or wide area network communication, or to the payment server function (Backend) using wide area network communication (882).

XI. The computerized method (100) according to any of clauses I-IX, wherein:
the payer communication device (PD1) makes a payment request (820) at the payment service provider (Issuer), wherein the payment request includes at least some of the transaction data (TBS) for the digital payment;
the payment service provider registers (110; 836) the transaction data (TBS), wherein the payment amount (Amount) is reserved (833) in said managed account (dcaccount);
the payment service provider signs (120; 838) the transaction data by means of the private cryptographic key (dcaccount_priv_key) as kept secure by the payment service provider; and
the payment service provider communicates (130) the signed transaction data (P, TBS) to one of:
   the payer communication device using wide area network communication (842), for forwarding by the payer communication device to the payee communication device (PD2) using short-range data communication (844) or wide area network communication,
   the payee communication device (PD2) using wide area network communication (846), and
   the payment server function (Backend) using wide area network communication (848).

XII. The computerized method (100) according to any preceding clause, wherein the public cryptographic key (dcaccount_pub_key; dcwallet_pub_key) is included in a digital certificate (dcaccount_cert; dcwallet_cert) which can be authenticated, directly or indirectly, by means of a root digital certificate (ca_root_cert) of a certificate authority (CA) being independent from the entities of the digital payment system (1).

XIII. The computerized method (100) according to clause XII, said digital certificate (dcaccount_cert; dcwallet_cert) having being signed by the payment service provider (Issuer) using a private key associated with an intermediate digital certificate (dc_root_cert), wherein the intermediate digital certificate can be authenticated in turn by means of said root digital certificate (ca_root cert).

XIV. The computerized method (100) according to any preceding clause, wherein actual knowledge of a true identity of the person having the alias (PayerAlias) of the payer is not a mandatory requirement for performing the digital payment.

XV. The computerized method (100) according to any preceding clause, wherein actual knowledge of a true identity of the person having the alias (PayeeAlias) of the payee is not a mandatory requirement for settlement of the digital payment.

XVI. The computerized method (100) according to clause XIV or XV, wherein actual knowledge of the true identity is required only when the digital payment exceeds one or more threshold criteria.

XVII. The computerized method (100) according to clause XVI, wherein said one or more threshold criteria include constraints on one or more of the following: payment amount, payer location, payee location, type of payment, intended payment sender, and intended payment receiver.

XVIII. The computerized method (100) according to any of clauses XIV-XVII, further involving, at the registering (110) of transaction data (TBS) for the digital payment:
the payment service provider (Issuer) checking (832) whether the payment amount (Amount) falls outside of the boundaries of a payment limit (PayerAlias_KYC_RL) for the payer (P1) and, if so:
requesting (832a) further information (KYC) about the payer (PD1), in addition to the alias of the payer (PayerAlias).

XIX. The computerized method (100) according to any of clauses XIV-XVIII, further involving, at settlement (150) of the digital payment:
the computerized payment server function (Backend) checking (1042) whether the payment amount (Amount) falls outside of the boundaries of a payment limit (PayeeAlias_KYC_RL) for the payee (P2) and, if so:
requesting (1052a) further information (KYC) about the payee (PD2), in addition to the alias of the payee (PayeeAlias).

XX. The computerized method (100) according to any preceding clause, wherein the representation of the payment amount (Amount) is a digital token or a numerical value.

XXI. The computerized method (100) according to clause II, wherein the signed transaction data (P, TBS) is communicated (130) to the payee communication device (PD2; 400) in a message (842-848) which begins with the specification of the verification resource (url_hook) in the form of a uniform resource locator, thereby allowing invocation of a web browser application (411) in the payee communication device and making the verification request (134; 912) over a browser-to-browser connection with the payment service provider (Issuer) or payment server function (Backend).

XXII. The computerized method (100) according to clause I, further comprising:
the computerized payment server function (Backend) receiving (848) the signed transaction data (P, TBS) from the computerized payment service provider (Issuer);
the computerized payment server function (Backend) verifying (932) the signed transaction data (P, TBS);
the computerized payment server function (Backend) communicating (940) a verification result to the payee communication device (PD2);
the payee communication device (PD2) receiving the verification result; and
conditionally upon a successful verification being indicated by the verification result, the payee communication device (PD2) providing a goods or performing a service associated with the digital payment.

XXIII. A digital payment system (1) for performing a digital payment by a payer (P1) to a payee (P2), the digital payment system comprising at least the following entities:
a computerized payment service provider (Issuer);
a payer communication device (PD1) for use by the payer;
a payee communication device (PD2) for use by the payee; and
a computerized payment server function (Backend),
wherein at least one of the computerized payment service provider and payer communication device is configured for:
   registering transaction data (TBS) for the digital payment, the transaction data comprising an alias (PayerAlias) of the payer, an alias (PayeeAlias) of the payee, and a representation of a payment amount (Amount) which is covered by a reservation of funds in an account (dcaccount) managed by the payment service provider,
   signing of the transaction data by means of a private cryptographic key (dcaccount_priv_key; dcwallet_priv_key) kept secure by the payment service provider or payer communication device,
   communicating the signed transaction data (P, TBS) to cause verification at the payment service provider or payment server function by means of a certified public cryptographic key (dcaccount_pub_key; dcwallet_pub_key) corresponding to the private cryptographic key; and
wherein the digital payment system is further configured for:
   subject to successful verification, enabling settlement of the digital payment by releasing the payment amount from the reservation of funds, deducting funds from a balance of said account and adding funds to an account associated with the payee, the deduction and addition corresponding to the payment amount.

XXIV. The digital payment system (1) as defined in clause XXIII, further configured for performing the functionality as defined for the method according to any of clauses II-XXII.

XXV. A cloud-based computing resource configured to perform the functionality of the computerized payment server function (Backend) in the method (100) as defined by any of clauses I-XXII.

XXVI. A cloud-based computing resource configured to perform the functionality of the computerized payment service provider (Issuer) in the method (100) as defined by any of clauses I-XXII.

XXVII. A communication device (300) configured to perform the functionality of the payer communication device (PD1) in the method (100) as defined by any of clauses I-XXII.

XXVIII. The communication device (300) as defined in clause XXVII, wherein the communication device is one of the following: a mobile communication device; a mobile phone; a smart phone; a tablet computer; a personal digital assistant; a portable computer; smart glasses; a smart wearable; a smart watch; a smart bracelet; a smart card; and a smart chip.

XXIX. A communication device (400) configured to perform the functionality of the payee communication device (PD2) in the method (100) as defined by any of clauses I-XXII.

XXX. The communication device (400) as defined in clause XXIX, wherein the communication device is one of the following: a mobile communication device; a mobile phone; a smart phone; a tablet computer; a personal digital assistant; a portable computer; smart glasses; a smart watch; a smart card; a smart bracelet; a smart wearable; a payment terminal, a service terminal; a point-of-sales terminal; a checkout counter; a delivery pickup point; a vending machine; a ticket machine; a dispensing machine; and an access control system.

XXXI. A computer program product comprising computer code for performing the functionality of the computerized payment server function (Backend) in the method according to any of clauses I-XXII when the computer program code is executed by a processing device.

XXXII. A computer program product comprising computer code for performing the functionality of the computerized payment service provider (Issuer) in the method according to any of clauses I-XXII when the computer program code is executed by a processing device.

XXXIII. A computer program product comprising computer code for performing the functionality of the payer communication device (PD1) in the method according to any of clauses I-XXII when the computer program code is executed by a processing device.

XXXIV. A computer program product comprising computer code for performing the functionality of the payee communication device (PD2) in the method according to any of clauses I-XXII when the computer program code is executed by a processing device.

XXXV. A computer readable medium having stored thereon a computer program comprising computer program code for performing the functionality of the computerized payment server function (Backend) in the method according to any of clauses I-XXII when the computer program code is executed by a processing device.

XXXVI. A computer readable medium having stored thereon a computer program comprising computer program code for performing the functionality of the computerized payment service provider (Issuer) in the method according to any of clauses I-XXII when the computer program code is executed by a processing device.

XXXVII. A computer readable medium having stored thereon a computer program comprising computer program code for performing the functionality of the payer communication device (PD2) in the method according to any of clauses I-XXII when the computer program code is executed by a processing device.

XXXVIII. A computer readable medium having stored thereon a computer program comprising computer program code for performing the functionality of the payee communication device (PD2) in the method according to any of clauses I-XXII when the computer program code is executed by a processing device.

1-36. (canceled)

37. A computerized method of performing a digital payment by a payer to a payee in a digital payment system which comprises at least the following entities: a computerized payment service provider, a payer communication device for use by the payer, a payee communication device for use by the payee, and a computerized payment server function, wherein the computerized method involves:
registering transaction data for the digital payment, the transaction data comprising an alias of the payer, an alias of the payee, and a representation of a payment amount which is covered by a reservation of funds in an account managed by the payment service provider;
signing of the transaction data by means of a private cryptographic key kept secure by the payment service provider or payer communication device;
communicating the signed transaction data to cause verification at the payment service provider or payment server function by means of a certified public cryptographic key corresponding to the private cryptographic key; and
subject to successful verification, enabling settlement of the digital payment by releasing the payment amount from the reservation of funds, deducting funds from a balance of said account and adding funds to an account associated with the payee, the deduction and addition corresponding to the payment amount.

38. The computerized method according to claim 37, further comprising the payee communication device:
receiving the signed transaction data, wherein the signed transaction data includes a specification of a verification resource; and
using the received data to make a verification request at the payment service provider or payment server function.

39. The computerized method according to claim 37, further comprising the payee communication device:
receiving a verification result from the payment service provider or payment server function; and
conditionally upon a successful verification being indicated by the verification result, providing a goods or performing a service associated with the digital payment.

40. The computerized method according to claim 37, further comprising the payee communication device:
receiving a verification result from the payment service provider or payment server function; and
conditionally upon a successful verification being indicated by the verification result, making a settlement request at the payment service provider or payment server function.

41. The computerized method according to claim 37, wherein upon successful verification of the signed transaction data, the payment service provider or payment server function causes settlement of the digital payment.

42. The computerized method according to claim 37, wherein after settlement of the digital payment, the payment service provider or payment server function sends a payment confirmation message to the payee communication device.

43. The computerized method according to claim 37, wherein execution of the method requires no preparatory interaction between the payee communication device and the other entities of the digital payment system.

44. The computerized method according to claim 37, further comprising the payee communication device:
receiving the signed transaction data, wherein account option data is included therein or enclosed therewith; and
using the account option data to make a request for establishment of said account associated with the payee prior to settlement of the digital payment.

45. The computerized method according to claim 37, further comprising an initial step of the payee communication device providing at least some of the transaction data for the digital payment to the payer communication device.

46. The computerized method according to claim 37, wherein:
the payer communication device comprises a digital wallet in local storage;
the digital wallet comprises a local balance having been reserved in the account managed by the payment service provider;
the payer communication device registers the transaction data for the digital payment, wherein the local balance of the digital wallet is reduced by the payment amount;
the payer communication device signs the transaction data by means of the private cryptographic key as kept secure by the payer communication device; and
the payer communication device communicates the signed transaction data either to the payee communication device using short-range data communication or wide area network communication, or to the payment server function using wide area network communication.

47. The computerized method according to claim 37, wherein:
the payer communication device makes a payment request at the payment service provider, wherein the payment request includes at least some of the transaction data for the digital payment;
the payment service provider registers the transaction data, wherein the payment amount is reserved in said managed account;
the payment service provider signs the transaction data by means of the private cryptographic key as kept secure by the payment service provider; and
the payment service provider communicates the signed transaction data to one of:
the payer communication device using wide area network communication, for forwarding by the payer communication device to the payee communication device using short-range data communication or wide area network communication,
the payee communication device using wide area network communication, and
the payment server function using wide area network communication.

48. The computerized method according to claim 37, wherein the public cryptographic key is included in a digital certificate which can be authenticated, directly or indirectly, by means of a root digital certificate of a certificate authority being independent from the entities of the digital payment system.

49. The computerized method according to claim 48, said digital certificate having being signed by the payment service provider using a private key associated with an intermediate digital certificate, wherein the intermediate digital certificate can be authenticated in turn by means of said root digital certificate.

50. The computerized method according to claim 37, wherein actual knowledge of a true identity of a person having the alias of the payer is not a mandatory requirement for performing the digital payment.

51. The computerized method according to claim 37, wherein actual knowledge of a true identity of a person having the alias of the payee is not a mandatory requirement for settlement of the digital payment.

52. The computerized method according to claim 37, wherein actual knowledge of a true identity of a person having the alias of the payer or of a true identity of a person having the alias of the payee is required only when the digital payment exceeds one or more threshold criteria.

53. The computerized method according to claim 52, wherein said one or more threshold criteria include constraints on one or more of the following:
payment amount, payer location, payee location, type of payment, intended payment sender, and intended payment receiver.

54. The computerized method according to claim 37, further involving, at the registering of transaction data for the digital payment:
the payment service provider checking whether the payment amount falls outside of boundaries of a payment limit for the payer and, if so:
requesting further information about the payer, in addition to the alias of the payer.

55. The computerized method according to claim 37, further involving, at settlement of the digital payment:
the computerized payment server function checking whether the payment amount falls outside of boundaries of a payment limit for the payee and, if so:
requesting further information about the payee, in addition to the alias of the payee.

56. The computerized method according to claim 37, wherein the representation of the payment amount is a digital token or a numerical value.

57. The computerized method according to claim 38, wherein the signed transaction data is communicated to the payee communication device in a message which begins with the specification of the verification resource in the form of a uniform resource locator, thereby allowing invocation of a web browser application in the payee communication device and making the verification request over a browser-to-browser connection with the payment service provider or payment server function.

58. The computerized method according to claim 37, further comprising:
the computerized payment server function receiving the signed transaction data from the computerized payment service provider;
the computerized payment server function verifying the signed transaction data;
the computerized payment server function communicating a verification result to the payee communication device;
the payee communication device receiving the verification result; and
conditionally upon a successful verification being indicated by the verification result, the payee communication device providing a goods or performing a service associated with the digital payment.

59. A digital payment system for performing a digital payment by a payer to a payee, the digital payment system comprising at least the following entities:
a computerized payment service provider;
a payer communication device for use by the payer;
a payee communication device for use by the payee; and
a computerized payment server function,
wherein at least one of the computerized payment service provider and payer communication device is configured for:
registering transaction data for the digital payment, the transaction data comprising an alias of the payer, an alias of the payee, and a representation of a payment amount which is covered by a reservation of funds in an account managed by the payment service provider,
signing of the transaction data by means of a private cryptographic key kept secure by the payment service provider or payer communication device,
communicating the signed transaction data to cause verification at the payment service provider or payment server function by means of a certified public cryptographic key corresponding to the private cryptographic key, and
wherein the digital payment system is further configured for:
subject to successful verification, enabling settlement of the digital payment by releasing the payment amount from the reservation of funds, deducting funds from a balance of said account and adding funds to an account associated with the payee, the deduction and addition corresponding to the payment amount.

60. A cloud-based computing resource configured to perform the functionality of the computerized payment server function in the method as defined in claim 37.

61. A cloud-based computing resource configured to perform the functionality of the computerized payment service provider in the method as defined in claim 37.

62. A communication device configured to perform the functionality of the payer communication device in the method as defined in claim 37, wherein the communication device is selected from the group consisting of:
a mobile communication device; a mobile phone; a smart phone; a tablet computer; a personal digital assistant; a portable computer; smart glasses; a smart wearable; a smart watch; a smart bracelet; a smart card; and a smart chip.

63. A communication device configured to perform the functionality of the payee communication device in the method as defined in claim 37, wherein the communication device is selected from the group consisting of:
a mobile communication device; a mobile phone; a smart phone; a tablet computer; a personal digital assistant; a portable computer; smart glasses; a smart watch; a smart card; a smart bracelet; a smart wearable; a payment terminal, a service terminal; a point-of-sales terminal; a checkout counter; a delivery pickup point; a vending machine; a ticket machine; a dispensing machine; and an access control system.

64. A tangible, non-volatile computer readable medium having stored thereon a computer program comprising computer program code for performing the functionality of the computerized payment server function in the method as defined in claim 37 when the computer program code is executed by a processing device.

65. A tangible, non-volatile computer readable medium having stored thereon a computer program comprising computer program code for performing the functionality of the computerized payment service provider in the method as defined in claim 37 when the computer program code is executed by a processing device.

66. A tangible, non-volatile computer readable medium having stored thereon a computer program comprising computer program code for performing the functionality of the payer communication device in the method as defined in claim 37 when the computer program code is executed by a processing device.

67. A tangible, non-volatile computer readable medium having stored thereon a computer program comprising computer program code for performing the functionality of the payee communication device in the method as defined in claim 37 when the computer program code is executed by a processing device.
